(19) United States
(12) Patent Application Publication
(10) Pub. No.: US 2006/0031580 A1
(43) Pub. Date: Feb. 9, 2006

(54) System and method for converting and transmitting data

(76) Inventor: Byoung-Chul Kim, Jeollabuk-do (KR)

Correspondence Address: Alan B Clement;Hedman & Costigan, 1185 Avenue of the Americas, New York, NY, 10036, US

(21) Appl. No.: 10/526,333

(22) PCT Filed: Sep. 1, 2003
(86) PCT No.: PCT/KR03/01786

§ 371 Date: Mar. 1, 2005

(30) Foreign Application Priority Data
Sep. 4, 2002 (KR) 10-2002-0053088

(51) Int. Cl. G06F 15/16

(52) U.S. Cl. 709/246

(57) ABSTRACT

Disclosed is a data conversion and transmission system including: wire and wireless terminal clients; a management server connected with the wire and wireless terminal clients over the internet; and a data server connected to the management server, wherein the wire and wireless terminal clients for information provision receive an input form corresponding to to-be-provided information among input forms stored in the data server from the management server to provide the information, and wherein the management server extracts requested information from the data server according to requests of the wire and wireless terminal clients for information access to convert the extracted information into a format adaptive to a specification (protocol) and a platform of the wire and wireless terminal clients, for provision.

### TECHNICAL FIELD

The present invention relates to a system and method for data conversion and transmission, and more particularly, to a system and method for data conversion and transmission in which, if an information provider uses an input form provided from a management server to input information through a wire or wireless terminal device, the information inputted from the management server is converted into a format adaptive to be provided for the wireless or wire terminal device for transmission such that one input form is used to provide information desired by a user of various kinds of wire and wireless terminal devices.

### BACKGROUND ART

As a personal computer is widely used, the number of internet users tends to explosively increase, and as internet is generalized, a variety of information related to politics, economy, society, education and culture are provided for the internet users over the internet.

However, since providing the information over the internet is performed in a way in which the information provider provides and bulletins information at a specific Web site, the internet users not acknowledging an address of a corresponding Web site suffer from an inconvenience in that a retrieval engine should be used to obtain corresponding information and further the retrieved result is again individually retrieved for the desired information. In order to solve this inconvenience, a messenger program associated with a Web server is used to provide a variety of information in real time, but in order to obtain the provided information, a computer system that can be connected to the Web server should be provided.

On the other hand, as one-way receiving means for the variety of information, a wireless terminal such as a portable phone or a wireless PDA (Personal digital assistant), etc. is widely used. The wireless terminal has advantageous characteristics that a high speedy transmission and reception of information can be made without limitation to time and location. Further, as a technology is developed, since the wireless terminal is used to enable transmission and reception of a voice message, a character message and a mobile image, etc., a basic function is necessarily embodied for a voice communication between subscribers, and various information, for example, information on weather, biorhythm, sports or stock, etc., which is the same as information provided over a general internet, is provided as additional information from a communication service company.

The above is described centering on a user provided with information, but even in view of the information provider for providing information, information can be provided over the internet, or over the wireless terminal.

Specifically, a conventional method for providing information using the wireless terminal has an advantage in that information can be provided in real time in a region where an internet resource is not built, for example, even in an island group or mountainous region and an insular region.

As described above, information collected from the information providers should be again promptly provided for the users in real time to increase an information efficiency.

However, the conventional method has a drawback in that since information collected over a wire network including the computer system and the internet, and information collected through the wireless terminal and the wireless network has different formats from each other, it is difficult for a counterpart to use the collected information.

Furthermore, the conventional art has a drawback in that the information collected over the wireless network cannot be shared depending on a kind and a platform of the wireless terminal.

Resultantly, the conventional art has an inconvenience in that information individually collected over the wire and wireless networks needs to be mutually converted and provided.

### DISCLOSURE OF THE INVENTION

Therefore, the present invention has been made in an effort to solve the problems of the related art.

An object of the present invention is to provide a system and method for data conversion and transmission in which various information collected over wire and wireless networks can be automatically converted into a format adaptive to a kind or a platform of each terminal device for provision.

Another object of the present invention is to provide a system and method for data conversion and transmission in which one input form can be commonly applied irrespective of a terminal device to collect information.

### BRIEF DESCRIPTION OF DRAWINGS

The above objects and other advantages of the present invention will become more apparent by describing in detail preferred embodiments thereof with reference to the attached drawings in which:

FIG. 1 is a view illustrating a network construction having a data conversion and transmission system applied according to a preferred embodiment of the present invention;

FIG. 2 is a block diagram illustrating a functional construction of a management server according to a preferred embodiment of the present invention;

FIG. 3 is a flow chart illustrating a procedure of information provision using a data conversion and transmission system according to a preferred embodiment of the present invention;

FIGS. 4A to 4C are examples illustrating input forms being used at the time of providing information; and

FIG. 5 is a flow chart illustrating a procedure of data conversion and transmission using a data conversion and transmission system according to a preferred embodiment of the present invention.

### BEST MODE FOR CARRYING OUR THE INVENTION

According to a first embodiment of the present invention, there is provided a data conversion and transmission system including: wire and wireless terminal clients; a management server connected with the wire and wireless terminal clients over the internet; and a data server connected to the management server, wherein the wire and wireless terminal clients for information provision receive an input form corresponding to to-be-provided information among input forms stored in the data server from the management server to provide the information, and wherein the management server extracts requested information from the data server according to requests of the wire and wireless terminal clients for information access to convert the extracted information into a format adaptive to a specification (protocol) and a platform of the wire and wireless terminal clients, for provision.

According to a second embodiment of the present invention, there is provided a data conversion and transmission system including: wire and wireless terminal clients; a wire server connected with the wire terminal client; a wireless server connected with the wireless terminal client; and a data server and a data conversion and transmission server shared by the wire and wireless servers, wherein the data conversion and transmission server extracts an input form requested by the wire terminal client for information provision, correspondingly to an information kind and from the data server to provide the extracted input form, and stores, in the data server, the information provided from the wire terminal client through the input form, and extracts information requested by the wireless terminal client for information access from the data server to convert the extracted information into a format adaptive to a mobile specification and a platform of the wireless terminal client for provision.

According to a third embodiment of the present invention, there is provided a data conversion and transmission system including: wire and wireless terminal clients; a wire server connected with the wire terminal client; a wireless server connected with the wireless terminal client; and a data server and a data conversion and transmission server shared by the wire and wireless servers, wherein the data conversion and transmission server extracts an input form requested by the wireless terminal client for information provision, correspondingly to an information kind and from the data server to provide the extracted input form, and stores, in the data server, the information provided from the wireless terminal client through the input form, and extracts information requested by the wire terminal client for information access from the data server to convert the extracted information into a format adaptive to a mobile specification and a platform of the wire terminal client for provision.

Preferably, the wire terminal client includes a computer system, and the wireless terminal client is any one of a mobile phone, a wireless PDA, or an IMT-2000 terminal.

According to a fourth embodiment of the present invention, there is provided a data conversion and transmission system including: wire and wireless terminal clients; a wire server connected with the wire terminal client; a wireless server connected with the wireless terminal client; and a data server and a data conversion and transmission server shared by the wire and wireless servers, wherein the data server includes an input form DB for storing an input form for receiving information from information providing wire and wireless terminal clients; an input information DB for storing information provided through the input form; a member information DB for storing user information provided at the time of member registration; and a wireless terminal information DB for storing information on a mobile specification and a platform of a wireless terminal used by a registered member, wherein the wire and wireless server includes a member management module for registering a user that desires information provision or information access as a member such that information on the registered user is stored and managed in the member information DB; a verification module for verifying whether or not the user connected to the wire or wireless server is the registered member; an information input management module for extracting an appropriate input form from the input form DB by requests of the information providing wire and wireless terminal clients to provide the extracted input form, and storing information provided from the information providing wire and wireless terminal clients in the input information DB; and a control module for controlling a mutual operation among respective modules, in which the data conversion and transmission server is controlled to store the information provided from the information providing wire and wireless terminal clients in the input information DB, or in which if the data conversion and transmission server converts extracted information adaptively to information accessing wire and wireless terminal clients by requests of the information accessing wire and wireless terminal clients, the converted information is transmitted to the information accessing wire and wireless terminal clients, and wherein the data conversion and transmission server stores, in case the information input management module transmits the information provided from the information accessing wire and wireless terminal clients, the transmitted information in the input information DB, and converts, in case information access is requested by the information accessing wire and wireless terminal clients, the stored information into a format adaptive to the information accessing wire and wireless terminal clients to provide the converted information.

According to a fifth embodiment of the present invention, there is provided a data conversion and transmission method including the steps of: in correspondence to information provided depending on requests of information providing wire and wireless terminal clients for information provision, transmitting an input form requested by the data server to be applied to the information providing wire and wireless terminal clients, and storing the information provided through the input form in the data server; transmitting terminal device information and an information kind of the information accessing wire and wireless terminal clients to the data conversion and transmission server by the wire and wireless servers if the information accessing wire and wireless terminal clients for information access are connected with the wire and wireless servers; extracting information coincident with the information kind of the transmitted information from the data server by the data conversion and transmission server; converting the extracted information into a format corresponding to the transmitted terminal device information by the data conversion and transmission server; and transmitting the converted information to a connected terminal device, wherein the method is applied to a data conversion and transmission system including wire and wireless terminal clients; a wire server connected with the wire terminal client; a wireless server connected with the wireless terminal client; and a data server and a data conversion and transmission server shared by the wire and wireless servers.

Preferably, the input form includes URL information of the wire and wireless servers.

Additionally, the information provided from the information providing wire and wireless terminal clients can have information on a region for which the information is provided

Preferably, in case the input form corresponding to the information provided from the information providing wire and wireless terminal clients does not exist, information to be inputted by the information providing wire and wireless terminal clients is analyzed such that the input form is created to be stored in the data server and simultaneously to be provided for the information providing wire and wireless terminal clients.

Preferably, the information provided from the information providing wire and wireless terminal clients is classified and stored by a member, and is classified by the information kind or an information accessing region to be stored in the data server.

Preferably, in case of the wire terminal client, the terminal device information is a management platform, and in case of the wireless terminal client, the terminal device information has a mobile specification (protocol) and a platform.

Preferably, the terminal device information on the wireless terminal client further includes current position information of the wireless terminal client.

Preferably, the converted format includes HTML or XML format in case of the wire terminal client, and includes WML, HDML, WinCE or JAVA format in case of the wireless terminal client.

Preferably, if the terminal device information on the information accessing wire and wireless terminal clients is transmitted to the data conversion and transmission server, the step of checking whether or not the connected wire and wireless terminal clients are supported on basis on the terminal device information can be further included.

Further, after information is provided through the input form to be stored in the data server, an input list of the provided information is displayed, and the provided information can be served or not served depending on a selection of the information providing wire and wireless terminal clients.

Now, preferred embodiments of the present invention will be described in detail with reference to the annexed drawings. First, in adding reference symbols to respective elements shown on the drawings, it is noted that identical elements are represented by an identical symbol if possible although they are shown in different drawings.

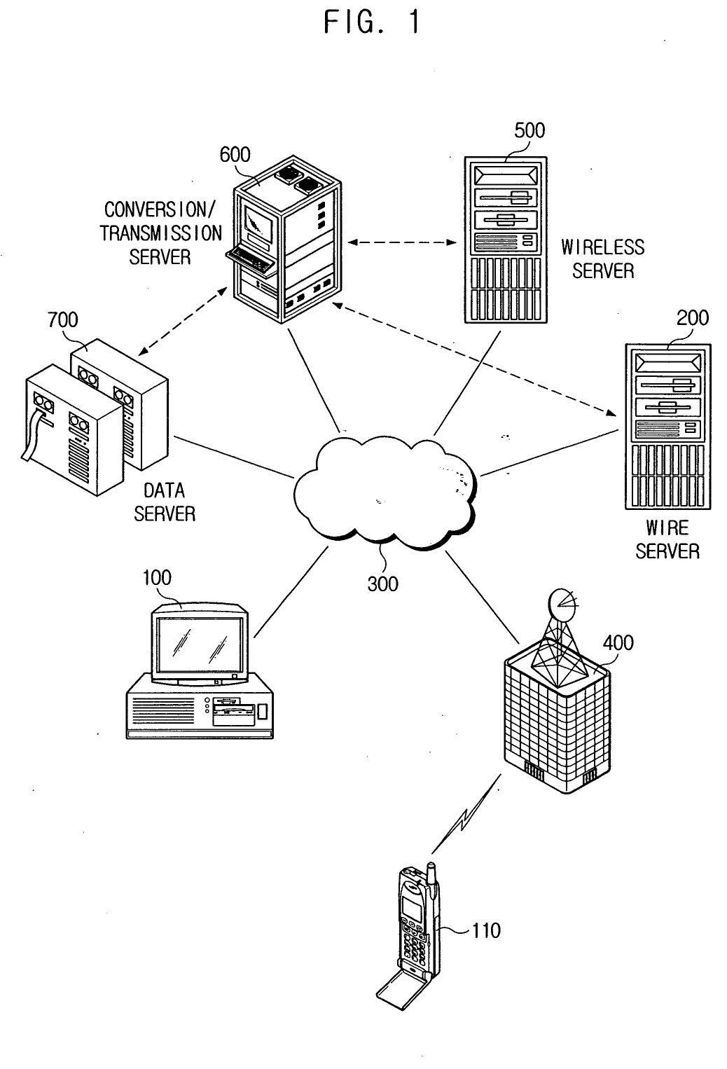

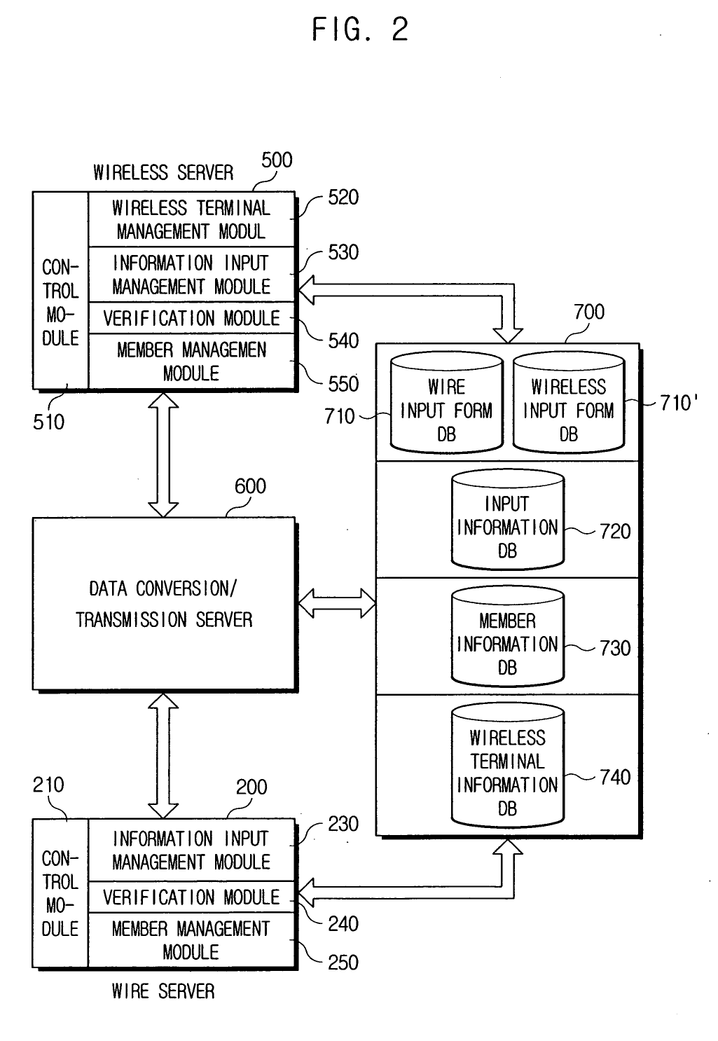

FIG. 1 is a view illustrating a network construction for showing a data conversion and transmission system for a wireless terminal according to a preferred embodiment of the present invention, and FIG. 2 is a block diagram illustrating a functional construction of a management server according to a preferred embodiment of the present invention.

Referring to FIG. 1, a wire terminal device 100 including a computer system, and a wireless terminal 110 including a mobile phone, a wireless PDA and IMT-2000, etc. can be also an information provider or an information user. Hereinafter, for description convenience, a description will be made centering on a type in which the computer system 100 provides information and the wireless terminal 110 is used to receive the information, and an opposite type thereto.

If the computer system 100 of the information provider requests an input form for information provision from a wire server 200 over the internet 300, after the wire server 200 provides a data conversion and transmission server 600 with an identification (ID) inputted at the time of connection to the computer system 100 to be verified, a corresponding input form is extracted and received from a data server 700 to transmit the received input form to the computer system 100, the information provider uses the transmitted input form to process obtained information and provide the processed information for the wire server 200, and if the wire server 200 transmits the collected information to the data conversion and transmission server 600, the data conversion and transmission server 600 stores the transmitted information in the data server 700.

Similarly, if a wireless server 500 is requested for desired information from the wireless terminal 110 through a mobile communication company server 400, the wireless server 500 transmits information on the connected wireless terminal together with the desired information to the data conversion and transmission server 600, and after the data conversion and transmission server 600 extracts the transmitted wireless terminal information, for example, the desired information after verified by a phone number, if the extracted information is converted adaptively to a mobile specification (protocol) and a platform of the connected wireless terminal to be provided for the wireless server 500, the wireless server 500 transmits the converted information to the wireless terminal 110.

Herein, the wire server 200 and the wireless server 500 are separated to distinguish respective functions, and actually they can be embodied in one management server, and the data server can be also built in the management server in a type of database. Further, FIG. 1 illustrates that the wire server, the wireless server and the data server are separately connected to the internet, but connection using a dedicated line can be also realized.

Referring to FIG. 2, respective functional constructions and data flows of the wire server, the wireless server, the data conversion and transmission server and the data server are illustrated according to the present invention.

The wire server 200 and the wireless server 500 are basically comprised of modules for embodying the same functions, and however, the wireless server 500 further includes, on its characteristics, a wireless terminal information management module for managing the wireless terminal information. Accordingly, in case of being integrated as the management server without distinguishing as to whether wire or wireless, respective common functional modules are included one by one.

The data server 700 includes wire and wireless input form database DB 710 and 710′, an input information DB 720, a member information DB 730 and a wireless terminal information DB 740.

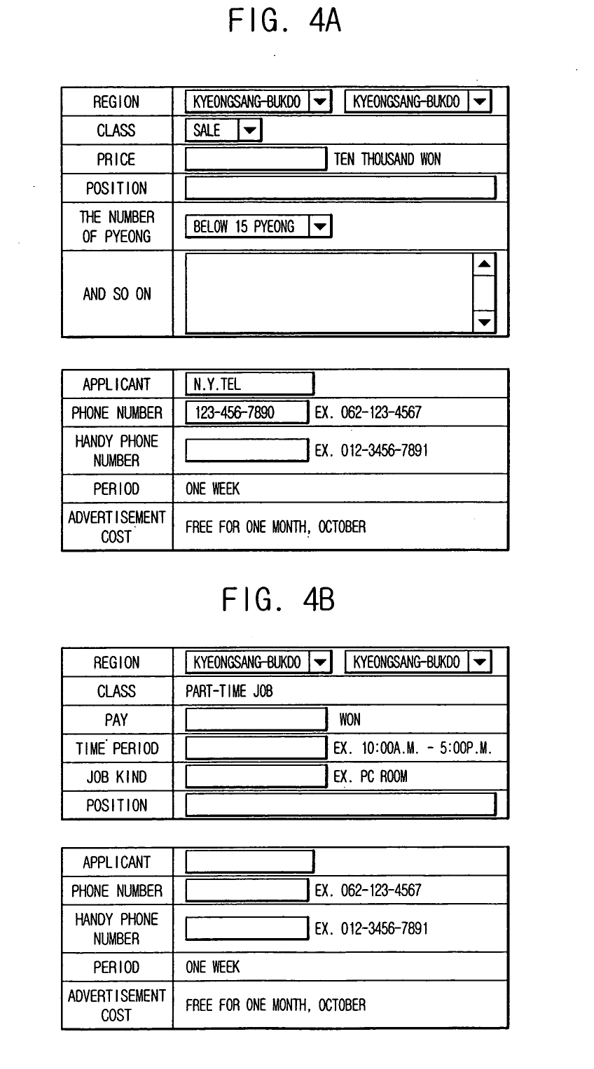

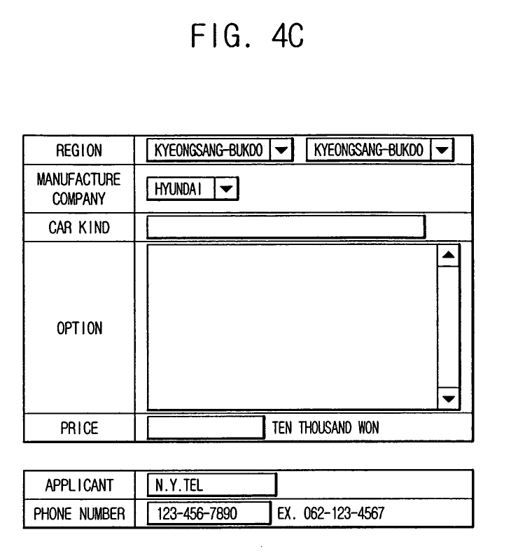

In the input form DB 710 and 720, the input form is stored as an input interface for facilitating the information provision from the information provider. For example, as shown in FIGS. 4A to 4C, various formats of input form are stored by a kind of inputted information such as real estate, car, job offering and hunting, or life information. The input form is managed in a separate database (DB) on device characteristics of the wire terminal device and the wireless terminal device, and the input form includes URL (Universe Resource Locator) information on the connected server.

In the input information DB 720 is stored information provided through the input form by the information provider. At this time, the inputted information is classified and stored by a member, and is also classified and stored by the kind of the inputted information or by an information accessing region. Further, in the input information DB 720 can be together stored particulars of information transmitted to the information user. In the input information DB 720 are stored text information and image information, and is stored original information not converted corresponding to each terminal device.

Furthermore, in the member information DB 730 is stored user information provided at the time of member registration. Additionally, the registered member keeps pace with a role of the information provider or the information user, and this is not necessarily determined at the time of registration. The user information, for example, a member ID, a password, a full name, a trade name, a phone number of the wireless terminal, an address and a transaction industry, etc. are stored.

Additionally, in the wireless terminal information DB 740 are stored a mobile specification, for example, the platform and information such as the phone number, a manufacture company, a size and a color-or-not of a display window, and a bell sound chord, etc. of the wireless terminal used by the registered member.

Such wireless terminal information is scanned at the time of first connection after member registration to be connected with and stored in the member information DB 730 with an index key as the phone number stored in the member information DB 730. Further, in the wireless terminal information DB 740 can be selectively stored a current position of the wireless terminal, and information on the position can use a global positioning system (GPS) satellite to be provided from the mobile communication company server or a position information providing company.

Member management modules 250 and 550 of the wire and wireless servers allow the user, that desire the information provision or the information access, to be registered as the member to store and manage the registered user in the member information DB 730. At this time, the member ID, the password, the phone number of the wireless terminal, and the address, etc. of the registered member are inputted as a basic term.

Verification modules 240 and 540 verify whether or not the user connected to the wire server 200 or the wireless server 500 is the registered member. In case of connection with the wire server 200, the inputted member ID and password are used to be compared with the member information DB 730, and in case of connection with the wireless server 500, the phone number is used among the wireless terminal information provided from the mobile communication company server 400 to be compared with the member information DB 730 such that it is checked whether or not the user is the registered member. Information input management modules 230 and 530 extract and provide an appropriate input form from the input form DB 710 and 710′ according to the request of the information provider. The information provided from the information provider is classified by the member, by an information kind, or by the information accessing region to be stored in the input information DB 720. The input form is previously manufactured adaptively to various mobile specification or platform and according to the information kind, and can be later manufactured and provided according to the request of the information provider. In case the wireless terminal 110 is connected to the wireless server 500 via the mobile communication company server 400, wireless terminal management module 520 checks the wireless terminal information to store and manage the checked information in the wireless terminal information DB 740. As described above, the mobile specification, for example, the platform and the information such as the phone number, the manufacture company, the size and the color-or-not of the display window, the bell sound chord, etc. of the wireless terminal are checked, and the current position of the wireless terminal can be selectively provided from the mobile communication company server or the position information providing company for storage. Control modules 210 and 510 control a mutual operation among respective modules, and control a data conversion and transmission server 600 such that the information provided from the information provider is stored in the input information DB 720, or such that if the data conversion and transmission server 600 converts the extracted information adaptively to the terminal device of the information user, the converted information is transmitted to the information user.

If the information input management modules 230 and 530 transmit the information provided from the information provider, the data conversion and transmission server 600 stores the transmitted information in the input information DB 720. At this time,.the stored information can be simply a text or an image. Further, if the information user requests for the information access, the data conversion and transmission server 600 converts the stored information into a format adaptive to the terminal device of the information user, for provision. For example, the converted format can be a format of HTML(Hyper Text Markup Language) or XML(Extensive Markup Language) for the wire terminal device, or a format of WML(Wireless Markup Language), HDML(HanDheld Markup Language), WinCE, JAVA for the wireless terminal device. Specifically, since even in the wireless terminal device are differentiated the platform for the mobile phone, the platform for the wireless PDA, and the platform for IMT-2000, etc. from one another, the stored information is converted into data adaptive to respective platforms, for provision.

Hereinafter, a detailed description will be made for an operation of the data conversion and transmission system according to a preferred embodiment of the present invention.

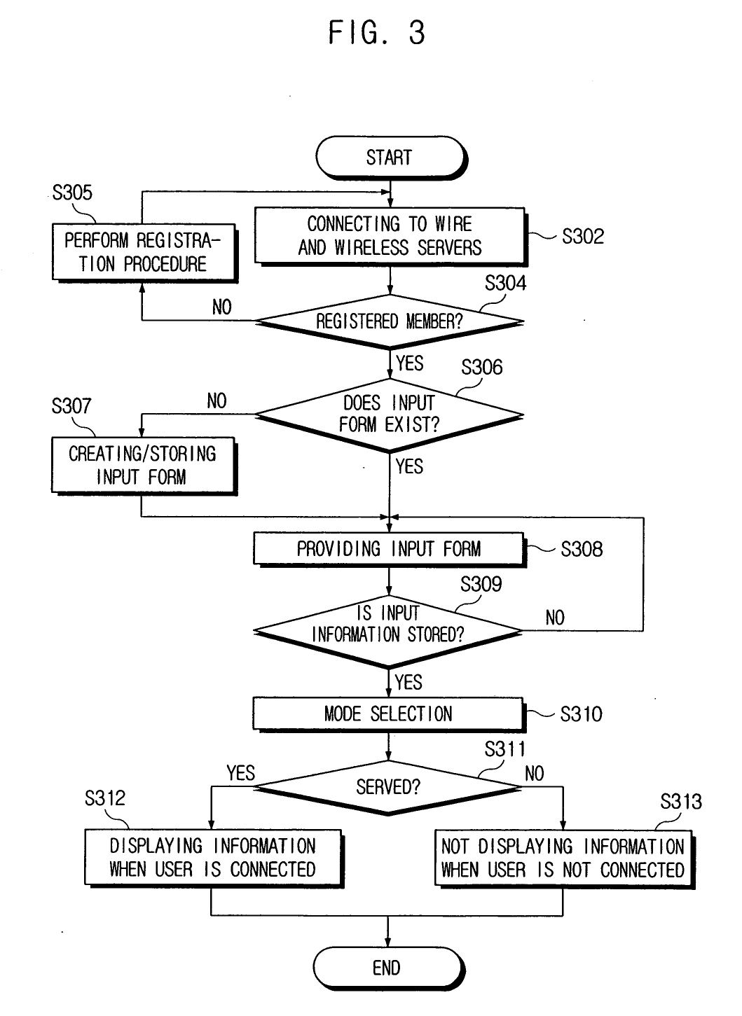

FIG. 3 is a flow chart illustrating a procedure of the information provision using the data conversion and transmission system according to a preferred embodiment of the present invention, and FIGS. 4A to 4C are examples illustrating the input forms used at the time of providing the information.

The user intending to provide or use the information is previously registered as the member, and the server-side member management modules 250 and 550 receive and store the user information in the member information DB 730.

In order to provide the processed information, the information provider uses the computer system or the mobile phone to connect to the wire server 200 or the wireless server 500 (S302).

If the connection is made, the verification modules 240 and 540 verify whether or not the connected user is the registered member (S304). The connection using the computer system can use the inputted member ID and password, and the connection using the mobile phone can use the phone number provided from the mobile communication company server 400.

In case the connected user is not the registered member, the registration procedure is performed (S303), and if he is verified as the registration member, he requests for the input form corresponding to the kind of information, which he himself intends to provide. The information input management modules 230 and 530 check whether the input form requested by the information provider exists (S306), and in case the input form does not exist, the information which the information provider intends to input is analyzed to create and store the input form in a corresponding input form DB 710 and 710′ and at the same time, provide the stored input form for the information provider (S307).

To the contrary, in case the input form exists, with reference to the kind of the information intended to be provided, the input form corresponding to the connected computer system or mobile phone is extracted from the input form DB 710 and 710′ to provide the extracted input form for the information provider (S308). The provided input form includes the URL information of the wire or wireless server to be connected.

The information provider uses the transmitted input form to provide the processed information, and the server-side control modules 210 and 510 control the data conversion and transmission server 600 to store the inputted information in the input information DB 720 (S309).

In case the information is provided, information on the information accessing region is included such that the provided information can be regionally limited to provide a substantial help.

Referring to FIG. 4A, illustrated is the case in which information on a real estate sale is provided, and terms of a region or position, a relation of sale or lease, etc., an acreage, a period and a phone number of the information provider, etc. are entered. Further, as shown in FIG. 4B, in case the information on the job offering and hunting is provided, the terms of the region, a job offering, a job hunting or a relation of part-time job, etc., a time period, a job kind, the position and the phone number of the information provider, etc. can be entered. Referring to FIG. 4C, illustrated is the case in which information on the car is provided, and terms of the region or manufacture company, a price and a phone number of the information provider, etc. are entered. Together with this, in case the information provider has a home page, a separate input can be made to a URL of the home page for provision.

Further, when the input information is stored, the input information is classified and stored by the member, and also can be classified and stored by the kind of the inputted information or the information accessing region.

In case of automatic storage, an input list is displayed for the information provided by the information provider, and the information provider selects a mode from the displayed input list as to whether information for a desired term is in service or the service is completed (S310).

It is checked whether the selected mode corresponds to the in-service (S311). In case of the in-service, when a general user connects to the server, the provided information is displayed (S312), and in case of completion of the service, when the general user connects to the server, the information is not displayed (S313).

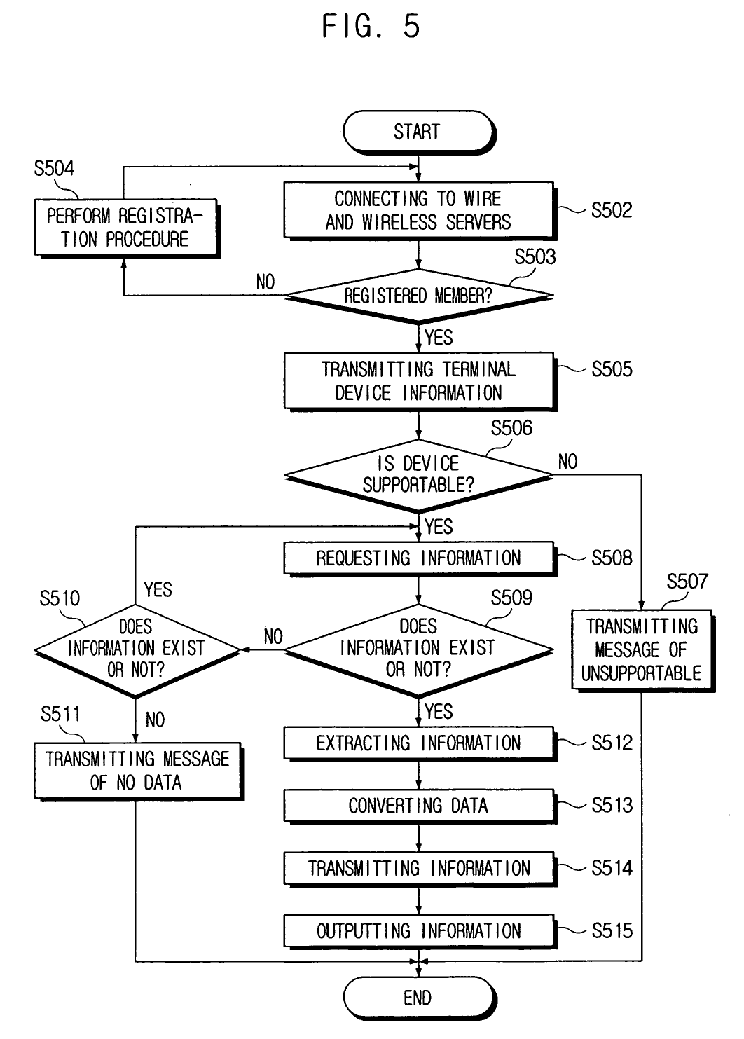

FIG. 5 is a flow chart illustrating a procedure of data conversion and transmission using the data conversion and transmission system according to a preferred embodiment of the present invention.

In order to use the processed information, the information user uses the computer system or the mobile phone to connect to the wire server 200 or the wireless server 500 (S502).

If the connection is made, the verification modules 240 and 540 verify whether the connected user is the registered member (S503). The connection with the computer system can use the inputted member ID and password, and the connection with the mobile phone can use the phone number provided from the mobile communication company server 400.

In case the connected user is not the registered member, the registration procedure is performed (S504), and if he is verified as the registration member, the control module 510 transmits the terminal device information of the terminal device connected to the data conversion and transmission server 600 (S505). That is, in case of the request from the computer system, the member ID is transmitted, and in case of the request from the mobile phone, the mobile specification, for example, the platform and the information of the phone number, the manufacture company, the size and the color-or-not of the display window, the bell sound chord, etc. of the wireless terminal is transmitted. Preferably, in case of the mobile phone, the current position information and a sex of the mobile phone user can be transmitted together.

Further, the wireless terminal management module 520 of the wireless server 500 receives the mobile specification and the platform from the control module to store the transmitted mobile specification and platform in the wireless terminal information DB 740.

The data conversion and transmission server 600 refers to the terminal device information such that it is checked whether or not the terminal device can be supported (S506) to transmit an alarm message of non-support in case of non-supported terminal device (S507), and to receive the request for the information in case of supported terminal device (S508).

The data conversion and transmission server 600 checks whether or not information exists uniting with the kind of the transmitted information (S509) such that in case the information does not exist, it is checked whether or not retrieval is again performed (S510). In case it is not desired that the retrieval is again performed, a message of no data is transmitted (S511). To the contrary, in case the information does exist, corresponding information is extracted from the input information DB 720 (S512). For example, in case the information user desires to obtain the job offering and hunting information with the region being limited to “Seoul”, the data conversion and transmission server 600 extracts the information related to “job offering and hunting” from the information with the region being limited to “Seoul” among the provided information. Further, preferably, when the connection is made by the mobile phone, the filtered information can be given to a corresponding region with reference to the current position information of the mobile phone. That is, the information with the region being limited to “Shinlim-dong” as a user's current position can be provided among the job offering and hunting information with the region being limited to “Seoul” such that the information user can be served by more substantial information.

The data conversion and transmission server 600 converts the extracted information into the format corresponding to the information on the connected terminal device (S513). For example, in case the connection is made through the computer system, information is provided in HTML or XML format, and in case of the connection through the mobile phone, information can be provided in WML format, and in case of the connection through the PDA, information can be provided in HDML, WinCE and JAVA formats.

Next, the control modules 210 and 510 transmit the converted information to the connected terminal device (S514).

Preferably, after the information is provided, a content of the provided information and a particular for the information user can be stored in the input information DB 720 to be used as a billing base.

The user can output the information transmitted and displayed on the display of the terminal device in an offline type depending on need (S515).

### INDUSTRIAL APPLICABILITY

As described above, the inventive data conversion and transmission system for the wireless terminal has an advantage in that one input form can be used to conveniently receive the information from the wire terminal device and the wireless terminal device, for storage.

Further, the inventive data conversion and transmission system has an advantage in that even though the connection is made to any one of the wire terminal device or the wireless terminal device so as to use the stored information, the stored information is converted adaptively to the connected terminal device for provision such that a hardware limitation is not caused by the connection.

Furthermore, the inventive data conversion and transmission system has an advantage in that, in case the information provider provides the information, the region for which the information is provided can be limited such that the information provider can limit and advertise the region, and the information user can obtain practical information without separate retrieval.

Additionally, the inventive data conversion and transmission system has an advantage in that in case the wireless terminal is used for connection to obtain the information, the current position is provided to promptly obtain realistic information related to the current position. While the present invention has been described in detail, it should be understood that various changes, substitutions and alterations can be made hereto without departing from the spirit and scope of the invention as defined by the appended claims.

1. A data conversion and transmission system comprising:
wire and wireless terminal clients;
a management server connected with the wire and wireless terminal clients over the internet; and
a data server connected to the management server, wherein the wire and wireless terminal clients for information provision receive an input form corresponding to to-be-provided information among input forms stored in the data server from the management server to provide the information, and
wherein the management server extracts requested information from the data server according to requests of the wire and wireless terminal clients for information access to convert the extracted information into a format adaptive to a specification (protocol) and a platform of the wire and wireless terminal clients, for provision.

2. A data conversion and transmission system comprising:
wire and wireless terminal clients;
a wire server connected with the wire terminal client;
a wireless server connected with the wireless terminal client; and
a data server and a data conversion and transmission server shared by the wire and wireless servers,
wherein the data conversion and transmission server extracts an input form requested by the wire terminal client for information provision, correspondingly to an information kind and from the data server to provide the extracted input form, and stores, in the data server, the information provided from the wire terminal client through the input form, and extracts information requested by the wireless terminal client for information access from the data server to convert the extracted information into a format adaptive to a mobile specification and a platform of the wireless terminal client for provision.

3. A data conversion and transmission system comprising:
wire and wireless terminal clients;
a wire server connected with the wire terminal client;
a wireless server connected with the wireless terminal client; and
a data server and a data conversion and transmission server shared by the wire and wireless servers,
wherein the data conversion and transmission server extracts an input form requested by the wireless terminal client for information provision, correspondingly to an information kind and from the data server to provide the extracted input form, and stores, in the data server, the information provided from the wireless terminal client through the input form, and extracts information requested by the wire terminal client for information access from the data server to convert the extracted information into a format adaptive to a mobile specification and a platform of the wire terminal client for provision.

4. The data conversion and transmission system of any one of claims 1 to 3, wherein the wire terminal client includes a computer system, and the wireless terminal client is any one of a mobile phone, a wireless PDA, or an IMT-2000 terminal.

5. A data conversion and transmission system comprising:
wire and wireless terminal clients;
a wire server connected with the wire terminal client;
a wireless server connected with the wireless terminal client; and
a data server and a data conversion and transmission server shared by the wire and wireless servers,
wherein the data server comprises an input form DB for storing an input form for receiving information from information providing wire and wireless terminal clients; an input information DB for storing information provided through the input form; a member information DB for storing user information provided at the time of member registration; and a wireless terminal information DB for storing information on a mobile specification and a platform of a wireless terminal used by a registered member,
wherein the wire and wireless server comprises a member management module for registering a user that desires information provision or information access as a member such that information on the registered user is stored and managed in the member information DB; a verification module for verifying whether or not the user connected to the wire or wireless server is the registered member; an information input management module for extracting an appropriate input form from the input form DB by requests of the information providing wire and wireless terminal clients to provide the extracted input form, and storing information provided from the information providing wire and wireless terminal clients in the input information DB; and a control module for controlling a mutual operation among respective modules, in which the data conversion and transmission server is controlled to store the information provided from the information providing wire and wireless terminal clients in the input information DB, or in which if the data conversion and transmission server converts extracted information adaptively to information accessing wire and wireless terminal clients by requests of the information accessing wire and wireless terminal clients, the converted information is transmitted to the information accessing wire and wireless terminal clients, and
wherein the data conversion and transmission server stores, in case the information input management module transmits the information provided from the information accessing wire and wireless terminal clients, the transmitted information in the input information DB, and converts, in case information access is requested by the information accessing wire and wireless terminal clients, the stored information into a format adaptive to the information accessing wire and wireless terminal clients to provide the converted information.

6. A data conversion and transmission method comprising the steps of:
in correspondence to information provided depending on requests of information providing wire and wireless terminal clients for information provision, transmitting an input form requested by the data server to be applied to the information providing wire and wireless terminal clients, and storing the information provided through the input form in the data server;
transmitting terminal device information and an information kind of the information accessing wire and wireless terminal clients to the data conversion and transmission server by the wire and wireless servers if the information accessing wire and wireless terminal clients for information access are connected with the wire and wireless servers;
extracting information coincident with the information kind of the transmitted information from the data server by the data conversion and transmission server;
converting the extracted information into a format corresponding to the transmitted terminal device information by the data conversion and transmission server; and transmitting the converted information to a connected terminal device,
wherein the method is applied to a data conversion and transmission system comprising wire and wireless terminal clients; a wire server connected with the wire terminal client; a wireless server connected with the wireless terminal client; and a data server and a data conversion and transmission server shared by the wire and wireless servers.

7. The data conversion and transmission method of claim 6, wherein the input form comprises URL information of the wire and wireless servers.

8. The data conversion and transmission method of claim 6, wherein the information provided from the information providing wire and wireless terminal clients has information on a region for which the information is provided

9. The data conversion and transmission method of claim 6, wherein in case the input form corresponding to the information provided from the information providing wire and wireless terminal clients does not exist, information to be inputted by the information providing wire and wireless terminal clients is analyzed such that the input form is created to be stored in the data server and simultaneously to be provided for the information providing wire and wireless terminal clients.

10. The data conversion and transmission method of claim 6, wherein the information provided from the information providing wire and wireless terminal clients is classified and stored by a member, and is classified by the information kind or an information accessing region to be stored in the data server.

11. The data conversion and transmission method of claim 6, wherein in case of the wire terminal client, the terminal device information is a management platform, and in case of the wireless terminal client, the terminal device information has a mobile specification (protocol) and a platform.

12. The data conversion and transmission method of claim 11, wherein the terminal device information on the wireless terminal client further comprises current position information of the wireless terminal client.

13. The data conversion and transmission method of claim 6, wherein the converted format comprises HTML or XML format in case of the wire terminal client, and comprises WML, HDML, WinCE or JAVA format in case of the wireless terminal client.

14. The data conversion and transmission method of claim 6, further comprising the step of checking whether or not the connected wire and wireless terminal clients are supported on basis on the terminal device information if the terminal device information on the information accessing wire and wireless terminal clients is transmitted to the data conversion and transmission server.

15. The data conversion and transmission method of claim 6, wherein after information is provided through the input form to be stored in the data server, an input list of the provided information is displayed, and the provided information is served or not served depending on a selection of the information providing wire and wireless terminal clients.
